(19) United States
(12) Patent Application Publication
(10) Pub. No.: US 2008/0091457 A1
(43) Pub. Date: Apr. 17, 2008

(54) SYSTEM AND METHOD FOR FACILITATING WEB-BASED TRANSACTIONS BETWEEN A BUYER AND A SELLER

(76) Inventor: Donn DELSON, Agoura Hills, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/872,255

(22) Filed: Oct. 15, 2007

Related U.S. Application Data
(60) Provisional application No. 60/829,409, filed on Oct. 13, 2006.

(51) Int. Cl. G06Q 30/00

(52) U.S. Cl. 705/1

(57) ABSTRACT

The subject application is directed to a system and method for facilitating web-based transactions between a buyer and a seller. A page request is first received from a buyer device by an operator server, which analyzes the request to determine a corresponding XML document. The XML document is then retrieved and analyzed to determine whether a pointer is contained therein, designating a specified XSL document. When no pointer is found, a default XSL document is requested from a seller server. When a pointer is found, the identified XSL document is requested from the seller server. The XML document and the XSL document are then used to generate a response to the page request, which is then transmitted to the user via a computer network.

### CROSS-REFERENCE TO RELATED APPLICATIONS

This application is based on and claims priority to U.S. Provisional Patent Application Ser. No. 60/829,409, filed on Oct. 13, 2006, the entirety of which is incorporated herein.

### BACKGROUND OF THE INVENTION

The subject application is directed to a web-based system and method for facilitating transactions between a buyer and a seller. More particularly, the subject application is directed to a system and method for using an operator server to facilitate a transaction between a buyer and a seller via a computer network.

The use of computer based sales is well-known to most businesses around the country, with some companies entirely based upon their Internet sales. Thus web pages, particularly those types of pages convenient and appealing to consumers are desired by the majority of commercial enterprises. However, for the commercial enterprise which manufactures only one type of product line, the likelihood of attracting a consumer to their website is limited to those consumers specifically looking for the manufacturer's product line.

For a real world, as opposed to an electronic world, example, large department stores offer consignment goods for sale to consumers shopping in its stores. The small boutique manufacturer of the goods has its own stores selling its goods, but realizes an increase in sales as a result of the goods sold on consignment to the department store. In a similar manner, the small manufacturer of specialized computer hardware has its own web site, but may realize greater sales if its hardware were sold on a site that also offered other computer related accessories.

Furthermore, the design and layout of a web page may cause a commercial enterprise to incur appreciable costs. The maintenance and constant updating of a web page requires the attention of a support staff, as well as additional designers. Stale, or stagnant, web pages may cause consumers to lose interest in a particular commercial enterprise's products, resulting in reduced revenues.

In addition, direct consumer access to the server of an online seller is a security risk for both the buyer and the seller. For example, the buyer's personal information is capable of being intercepted during transmission to the seller. Similarly, direct contact with the server of the seller opens the server up to attacks from parties outside of the transaction, including the compromising of the personal data stored thereon.

### SUMMARY OF THE INVENTION

In accordance with the subject application, there is provided a system and method for using an operator server to facilitate a transaction between a buyer and a seller via a computer network.

Further, in accordance with the subject application, there is provided a system and method for displaying item information on a buyer device using presentation data retrieved from a seller server by an operator server.

Yet further, in accordance with the subject application, there is provided a system and method for presenting information to a buyer corresponding to an item from a seller server via an operator server.

Still further, in accordance with the subject application, there is provided a system for facilitating web-based transactions between an associated buyer and an associated seller. The system comprises means adapted for receiving, from an associated buyer, request data in association with an associated seller, and means adapted for retrieving at least one first document in a first format in accordance with the request data. The system further comprises means adapted for requesting, from an associated seller, at least one second document in a second format. The at least one second document in the second format is associated with the at least one first document in the first format. The system further comprises means adapted for acquiring, from an associated seller, the requested at least one second document in the second format and means adapted for communicating a response to an associated buyer. The response is inclusive of the at least one second document in the second format acquired from an associated seller.

In accordance with one embodiment of the subject application, the at least one second document in the second format is one of the group consisting of a document in the second format specifically identified in the at least one first document in the first format, and a default document in the second format.

Further, in accordance with one embodiment of the subject application, the at least one first document in the first format is inclusive of a pointer to a specific at least one second document in the second format.

Still further, in accordance with one embodiment of the subject application, the system comprises means adapted for dynamically updating the pointer comprised in the at least one first document in the first format in response to the type of received request data.

Yet further, in accordance with one embodiment of the subject application, the first format is eXtensible Markup Language (XML) format, and the second format is eXtensible Stylesheet Language (XSL) format.

Yet further, in accordance with one embodiment of the subject application, the request data is web page data of an associated seller.

Still further, in accordance with one embodiment of the subject application, there is provided a method for facilitating web-based transactions between an associated buyer and an associated seller in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited for to carry out the subject application. As it will be realized, the subject application is capable of other different embodiments and its several details are capable of modifications in various obvious aspects all without departing from the scope of the subject application. Accordingly, the drawings and description will be regarded as illustrative in nature and not as restrictive.

### BRIEF DESCRIPTION OF THE DRAWINGS

The subject application is described with reference to certain figures, wherein:

FIG. 1 is an overall diagram of the system for facilitating web-based transactions between a buyer and a seller according to one embodiment of the subject application;

FIG. 2 is a block diagram illustrating a server for use in the system for facilitating web-based transactions between a buyer and a seller according to one embodiment of the subject application;

FIG. 3 is a flowchart illustrating a method for facilitating web-based transactions between a buyer and a seller according to one embodiment the subject application; and

FIG. 4 is a flowchart illustrating a method for facilitating web-based transactions between a buyer and a seller according to one embodiment the subject application.

### DETAILED DESCRIPTION OF THE PREFERRED EMBODIMENT

The subject application is directed to a system and method for facilitating web-based transactions between a buyer and a seller. In particular, the subject application is directed to a system and method for using an operator server to facilitate a transaction between a buyer and a seller via a computer network. More particularly, the subject application is directed to a system and method for displaying item information on a buyer device using presentation data retrieved from a seller server by an operator server. In addition, the subject application is directed to a system and method for presenting information to a buyer corresponding to an item or a service from a seller server via an operator server.

It will be appreciated by those skilled in the art that the use of the term “seller” is used herein to denote a merchant, retailer, or the like in an online transaction. The term “buyer” is used herein to refer to a user desiring to purchase an item or items from the seller, also referencing a client in a client/server relationship. Furthermore, the term “operator” is used herein to reference an online hosting service provider or transaction facilitating service provider, as will be understood by those skilled in the art. In addition, the seller and the operator are referenced below in conjunction with one or more servers. The skilled artisan will appreciate that a “server”, as used hereinafter, references any hardware, software, or combination thereof, suitably adapted to function as a server in the server/client relationship. Preferably, the servers included in the subject application are devices communicatively coupled to a distributed computing environment. It will be understood by those skilled in the art that the system described hereinafter is for example purposes only and any greater or lesser number of electronic devices is capable of being implemented in accordance with the subject application.

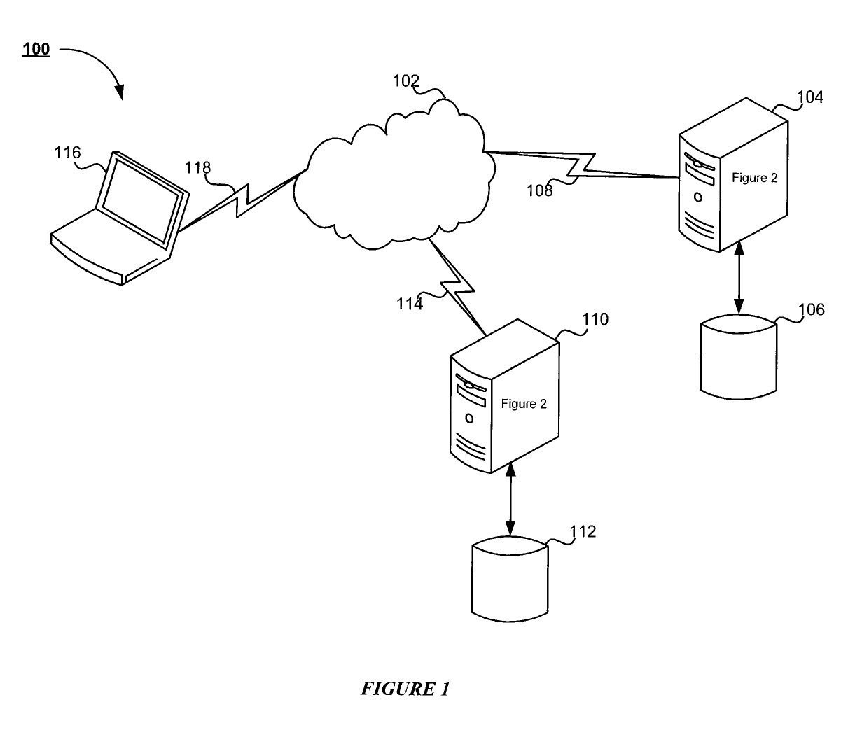

Referring now to FIG. 1, there is shown an overall diagram of the system 100 for facilitating web-based transactions between a buyer and a seller, using an operator server, in accordance with the subject application. As shown in FIG. 1, the system 100 employs a distributed computing environment, represented as a computer network 102. It will be appreciated by those skilled in the art that the computer network 102 is any distributed communications environment known in the art capable of enabling the exchange of data between two or more electronic devices. Those skilled in the art will further appreciate that the network 102 is any computer network known in the art including, for example and without limitation, a virtual area network, a local area network, a personal area network, the Internet, an intranet, a wide area network, or any suitable combination thereof. Preferably, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. In accordance with the preferred embodiment of the subject application, the computer network 102 is the Internet.

The system 100 further includes at least one seller server 104 in data communication with the computer network 102. As will be recognized by those skilled in the art, the system 100 shown in FIG. 1, includes one seller server 104 for illustration purposes only. A skilled artisan will further understand that plurality seller servers 104 are capable of being included in the system 100 without departing from the scope of the subject application. The skilled artisan will further appreciate that the seller server 104 is representative of any web-based goods or services provider, e.g., a consumer products retailer, known in the art, including, for example and without limitation, an online book retailer, an online music provider, an online clothing retailer, an online electronics retailer, an online services provider, an online ticket retailer, an online computer retailer, and the like. It will be understood by those skilled in the art that the seller server 104 is any software, hardware, or combination thereof, suitably adapted to communicate items or services for sale to the user via the computer network 102. The seller server 104 is communicatively coupled to the computer network 102 via a suitable communications link 108. The communications link 108 is any suitable means of data communication known in the art, including, for example and without limitation, infrared, optical, a proprietary communications network, the public switched telephone network, BLUETOOTH, WiMax, 802.11a, 802.11b, 802.11g, or 802.11(x), or any other suitable wire-based or wireless data transmission means known in the art. In accordance with one aspect of the subject application, the communications link 108 is capable of being implemented as a secure communications link, so as to enable the seller server 104 to receive secure user-related data via the computer network 102.

In accordance with the preferred embodiment of the subject application, the seller server 104 further includes a data storage device 106, communicatively coupled to the seller server 104, suitably adapted to provide user information storage, content data storage, network address data, presentation data, eXtensible Stylesheet Language (XSL) document storage, and the like. As will be understood by those skilled in the art, the data storage device 106 is any mass storage device known in the art including, for example and without limitation, a hard disk drive, other magnetic storage devices, optical storage devices, flash memory devices, or any combination thereof. It will be appreciated by those skilled in the art that while illustrated in FIG. 1 as being a separate component of the system 100, the data storage device 108 is capable of being implemented as internal storage of the seller server 104, such as, for example and without limitation, an internal hard disk drive, or the like.

As shown in FIG. 1, the system 100 also includes an operator server 110, suitably adapted to facilitate the communication between the seller server 104 and one or more user devices via the computer network 102. The skilled artisan will appreciate that the operator server 110 is any software, hardware, or combination thereof, suitably adapted to provide transaction services to the seller server 104 and a buyer device via the computer network 102. Suitable transaction services include, for example and without limitation, web-based hosting, eXtensible Markup Language (XML) document storage, secure communications, and the like. Preferably, the operator server 110 is coupled to the computer network 102 using a communications link 114. As will be understood by the skilled artisan, the communications link 114 is any suitable means of data communication known in the art, including, for example and without limitation, infrared, optical, a proprietary communications network, the public switched telephone network, BLUETOOTH, WiMax, 802.11a, 802.11b, 802.11g, or 802.11(x), or any other suitable wire-based or wireless data transmission means known in the art. In the preferred embodiment of the subject application, the communications link 114 is suitably adapted to provide a secure communications channel between the operator server 110 and any other electronic device coupled to the computer network 102, as will be appreciated by those skilled in the art. Preferably, the communications link 114 ensures the security of the data transmitted to and from the operator server 110 via the computer network 102 using data security protocols, such as web security protocols, in accordance with the subject application.

In accordance with the preferred embodiment of the subject application, the operator server 110 also includes a data storage device 112, in data communication with the operator server 110. Preferably, the data storage device 112 is suitably adapted to provide XML document storage, user information storage, content data storage, network address storage, and the like. As will be understood by those skilled in the art, the data storage device 112 is any mass storage device known in the art including, for example and without limitation, a hard disk drive, other magnetic storage devices, optical storage devices, flash memory devices, or any combination thereof. It will be appreciated by those skilled in the art that while illustrated in FIG. 1 as being a separate component of the system 100, the data storage device 112 is capable of being implemented as internal storage of the operator server 110, such as, for example and without limitation, an internal hard disk drive, or the like. It will be understood by those skilled in the art that the operator server 110, in accordance with one embodiment of the subject application, is capable of functioning as both a seller server 104 and an operator server 110, such as, for example and without limitation, when the operator server 110 hosts the seller's website.

The system 100 further includes a user, or buyer device 116, suitably adapted to communicate with the seller server 104, the operator server 110, or the like, via the computer network 102. Preferably, the buyer device 116 is communicatively coupled to the computer network 102 via a suitable communications link 118. It will be appreciated by those skilled in the art that the buyer device 116 is depicted in FIG. 1 as a laptop computer for illustration purposes only. As the skilled artisan will understand, the buyer device 116 shown in FIG. 1 is representative of any personal computing device known in the art, including, for example and without limitation, a computer workstation, a personal computer, a personal data assistant, a web-enabled cellular telephone, a smart phone, or other web-enabled electronic device. As will be further recognized by those skilled in the art, the buyer device 116 is representative of a plurality of buyer devices that are capable of being included in the system 100 without departing from the scope of the subject application. The communications link 118 is any suitable channel of data communications known in the art including, but not limited to wireless communications, for example and without limitation, BLUETOOTH, WiMax, 802.11a, 802.11b, 802.11g, 802.11(x), a proprietary communications network, infrared, optical, the public switched telephone network, or any suitable wireless data transmission system, or wired communications known in the art.

Preferably, the buyer device 116 is suitably configured to communicate with the servers 104 and 110 over the computer network 102 using a web browser. As will be understood by those skilled in the art, a web browser is any software application, known in the art, enabling the buyer device 116 to communicate with the Internet. Suitably browsers include, for example and without limitation, OPTERA, INTERNET EXPLORER, NETSCAPE NAVIGATOR, MOZILLA FIREFOX, or the like.

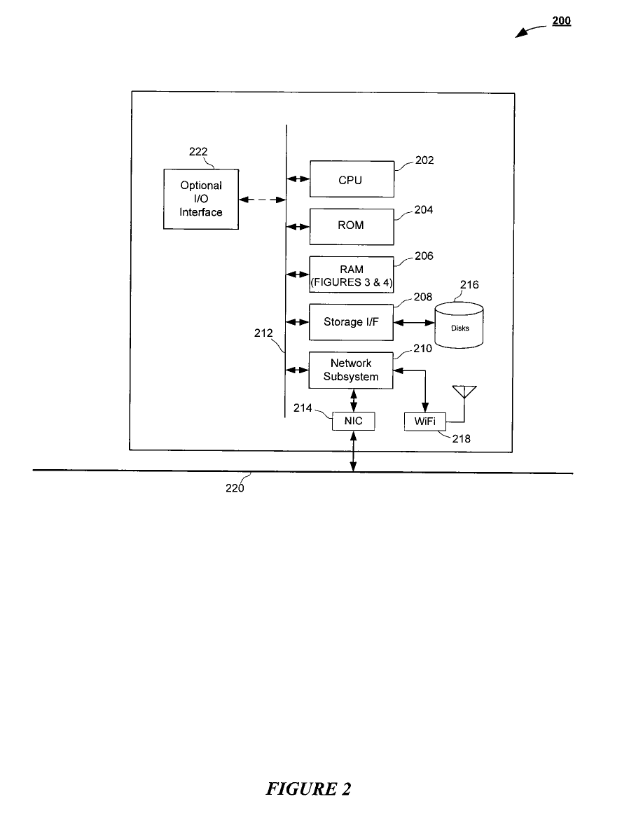

Referring now to FIG. 2, illustrated is a representative architecture of a suitable server 200 on which operations of the subject system are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration, and other routines or data used for operation of the server 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the server 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the server 200 to communicate to other devices. The network interface subsystem 210 suitably interfaces with one or more connections with external devices to the server 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the server 200 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 222 as will be appreciated by one of ordinary skill in the art.

In operation, a user, associated with the buyer device 116, first initiates a suitable web browser and connects with the computer network 102 via any suitable means known in the art. The buyer device 116, via the browser application, then requests data in association with a specific seller from the operator server 110. As will be appreciated by those skilled in the art, the request data suitably comprises a request for a web page, representative of an item or service which the seller offers for sale or provides. Preferably, the operator server 110 stores, in the data storage device 112, a plurality of pages, or XML documents, representative of items or services offered for sale by the seller. The operator server 110 receives the request data, retrieves an associated XML document and determines whether the XML document contains a pointer to a specific XSL document. When no such pointer is identified in the XML document, the operator server 110 requests a default XSL document from the seller server 104. When a pointer is identified in the XML document, the operator server 110 requests the XSL document identified in the XML document from the seller server 104. In accordance with one aspect of the subject application, the pointer contained in the XML document is dynamically updated in response to the type of information requested by the buyer device 116. In such an embodiment, the XSL document is capable of including, for example and without limitation, scripts to further alter the presentation of the data in the XML document, as will be understood by those skilled in the art.

A suitable example of the XML document, with pointer, is illustrated in TABLE 1:

TABLE 1

<xml>
<store>

<item id=‘0’ price=‘30.00’>

<itemName>First Item Name</itemName>

</item>
<item id=‘1’ price=‘27.00’>

<itemName>Second Item Name</itemName>

</item>

</store>
</xml>

As will be appreciated by those skilled in the art, no information with respect to the presentation of the data, e.g., item or service, exists on the operator server 110. Rather, the entirety of the presentation, e.g., styles, item content, description, etc., resides on the data storage device 106 of the seller server 104. In accordance with one aspect of the subject application, the seller server 104 is capable of being implemented as a component of the operator server 110, wherein all data would physically reside on the operator server 110, but would be virtually distinguishable as residing on the seller server 104. Preferably, the presentation information is implemented in the form of an XSL transformation stylesheet, as known in the art.

The requested XSL document is then received from the seller server 104 and is added to the response to the page request from the buyer device 116. The response, inclusive of the XSL document, is then returned to the buyer device 116, which displays the requested page, using the data contained in the XSL document, to the associated user. The operator server 110 then waits for any additional page requests from the buyer device 116. When additional requests are received, they are analyzed by the operator server 110 and the associated XSL file is requested from the seller server 104. Preferably, the communications between the operator server 110 and the seller server 104 are exchanged using a secure communications channel, as are known in the art.

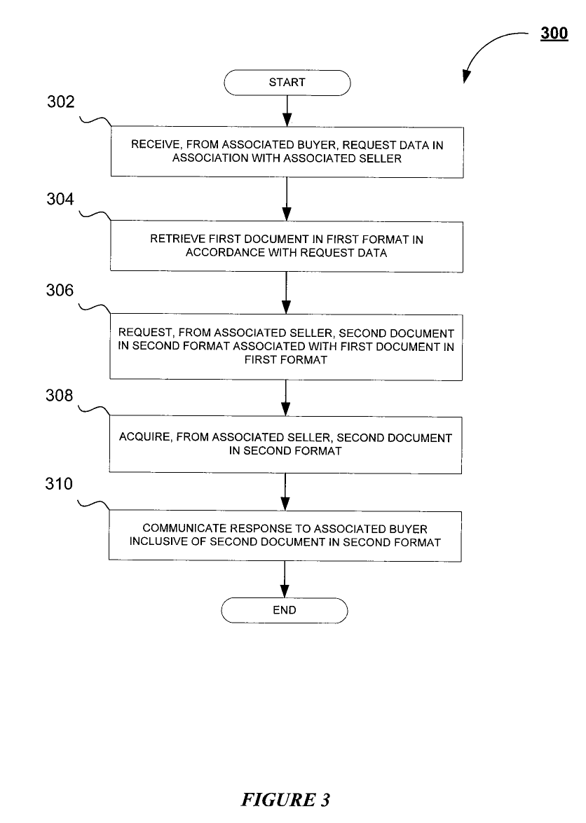

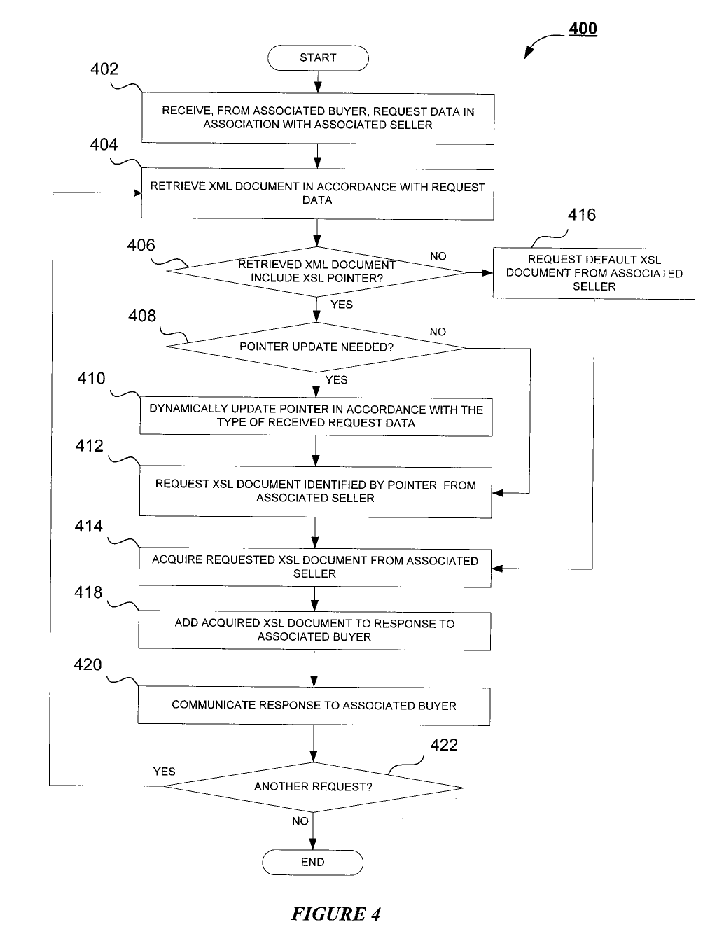

The foregoing system 100 will better be understood when viewed in conjunction with the methodology depicted in FIG. 3 and FIG. 4, discussed hereinafter. Turning now to FIG. 3, there is shown a flowchart 300 illustrating the method for facilitating web-based transactions between a buyer and a seller in accordance with one embodiment of the subject application. Beginning at step 302, the operator server 110 receives, from an associated buyer device 116, request data in association with an associated seller. As will be appreciated by a skilled artisan, the request data is received by the operator server 110 via the computer network 102. As will be further appreciated by those skilled in the art, the request data suitably comprises a request for a web page, representative of an item or service which the seller offers for sale or provides. Preferably, the operator server 110 stores, in the data storage device 112, a plurality of pages, or XML documents, representative of items or services offered for sale by the seller. The operator server 110 then, at step 304, retrieves from the data storage device 112, a first document in a first format, such as in XML format, in accordance with the request data. At step 306, the operator server 110 requests, from the seller server 104, a second document in a second format, such as in XSL format, which is associated with the first document. Those skilled in the art will recognize that the second document in the second format is capable of being stored, for example and without limitation, in the data storage device 106. The seller server 104 retrieves, from the data storage device 106, the second document associated with the first document, and flow then proceeds to step 308, at which step, the operator server 110 acquires from the seller server 104 the requested second document in the second format. Then, at step 310, the operator server 110 communicates via any suitable communication channel, such as network 102, a response to the buyer device 116. The response suitably includes the second document in the second format acquired from the seller server 104.

Referring now to FIG. 4, there is shown a flowchart 400 illustrating the method for facilitating web-based transactions between a buyer and a seller in accordance with one embodiment of the subject application. Beginning at step 402, the operator server 110 receives, from an associated buyer device 116, request data in association with an associated seller. As will be appreciated by a skilled artisan, the request data is received by the operator server 110 via the computer network 102. As will be further appreciated by those skilled in the art, the request data suitably comprises a request for a web page, representative of an item or service which the seller offers for sale or provides. Preferably, the operator server 110 stores, in the data storage device 112, a plurality of pages, or XML documents, representative of items or services offered for sale by the seller. The operator server 110 then, at step 404, retrieves from the data storage device 112, a document in XML format, in accordance with the request data. Flow then proceeds to step 406, whereupon a determination is made whether the retrieved XML document includes a pointer to an associated XSL document.

Upon a positive determination, that is when the XML document identifies a specific XSL document, as represented by the pointer, flow proceeds to step 408, at which step a determination is made whether the pointer included in the retrieved XML document is to be updated in accordance with the type of received request data. If the determination at step 408 is positive, then, at step 410, the pointer included in the retrieved XML document is dynamically updated. Flow then proceeds to step 412. Upon a negative determination at step 408, that is when it is determined that the pointer does not need an update, flow proceeds directly to step 412. Then at step 412, the operator server 110 requests, from the seller server 104, an XSL document, identified by the pointer included in the XML document, either dynamically updated, or not, depending on the determination made at step 408. Flow then proceeds to step 414.

Returning now to step 406, upon a negative determination, that is when it is determined at step 406, that the retrieved XML document does not include a pointer to an associated XSL document, flow proceeds to step 416. At step 416, the operator server 110 requests from the seller server 104, a default XSL document. Flow then progresses to step 414, at which step the operator server 110 acquires from the seller server 104 either the identified or default XSL document. Next, at step 418, the acquired XSL document, either the identified or default, is added by the operator server 110, to a response to the buyer device 116. The operator server 110 then communicates, at step 420, via a suitable communications channel, such as network 102, the response inclusive of the XSL document acquired from seller server 104, to the buyer device 116. A determination is then made at step 422 whether another request has been received from the buyer device 116. When no such request is received, preferably after a predetermined period of time, the operation terminates. When a subsequent request data is received from the buyer device 116, flow returns to step 404, and proceeds thereafter in accordance with the methodology discussed above.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the principles of the subject application as described, will fall within the scope of the subject application.

The foregoing description of a preferred embodiment of the subject application has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the subject application and its practical application to thereby enable one of ordinary skill in the art to use the invention in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for facilitating web-based transactions between an associated buyer and an associated seller comprising:
means adapted for receiving, from an associated buyer, request data in association with an associated seller;
means adapted for retrieving at least one first document in a first format in accordance with the request data;
means adapted for requesting, from an associated seller, at least one second document in a second format wherein the at least one second document in the second format is associated with the at least one first document in the first format;
means adapted for acquiring, from an associated seller, the requested at least one second document in the second format; and
means adapted for communicating a response to an associated buyer wherein the response is inclusive of the at least one second document in the second format acquired from an associated seller.

2. The system for facilitating web-based transactions between an associated buyer and an associated seller of claim 1 wherein the at least one second document in the second format is one of the group consisting of a document in the second format specifically identified in the at least one first document in the first format, and a default document in the second format.

3. The system for facilitating web-based transactions between an associated buyer and an associated seller of claim 2 wherein the at least one first document in the first format is inclusive of a pointer to a specific at least one second document in the second format.

4. The system for facilitating web-based transactions between an associated buyer and an associated seller of claim 4 further comprising means adapted for dynamically updating the pointer comprised in the at least one first document in the first format in accordance with the type of received request data.

5. A system for facilitating web-based transactions between an associated buyer and an associated seller of claim 1 wherein:
the first format is eXtensible Markup Language (XML) format; and
the second format is eXtensible Stylesheet Language (XSL) format.

6. A system for facilitating web-based transactions between an associated buyer and an associated seller of claim 1 wherein the request data is web page data of an associated seller.

7. A method for facilitating web-based transactions between an associated buyer and an associated seller comprising the steps of:
receiving, from an associated buyer, request data in association with an associated seller;
retrieving at least one first document in a first format in accordance with the request data;
requesting, from an associated seller, at least one second document in a second format wherein the at least one second document in the second format is associated with the at least one first document in the first format;
acquiring, from an associated seller, the requested at least one second document in the second format; and
communicating a response to an associated buyer wherein the response is inclusive of the at least one second document in the second format acquired from an associated seller.

8. The method for facilitating web-based transactions between an associated buyer and an associated seller of claim 7 wherein the at least one second document in the second format is one of the group consisting of a document in the second format specifically identified in the at least one first document in the first format, and a default document in the second format.

9. The method for facilitating web-based transactions between an associated buyer and an associated seller of claim 8 wherein the at least one first document in the first format is inclusive of a pointer to a specific at least one second document in the second format.

10. The method for facilitating web-based transactions between an associated buyer and an associated seller of claim 9 further comprising the step of dynamically updating the pointer comprised in the at least one first document in the first format in response to the type of received request data.

11. The method for facilitating web-based transactions between an associated buyer and an associated seller of claim 7 wherein:
the first format is eXtensible Markup Language (XML) format; and
the second format is eXtensible Stylesheet Language (XSL) format.

12. The method for facilitating web-based transactions between an associated buyer and an associated seller of claim 7 wherein the request data is web page data of an associated seller.

13. A computer-implemented method for facilitating web-based transactions between an associated buyer and an associated seller comprising the steps of:
receiving, from an associated buyer, request data in association with an associated seller;
retrieving at least one first document in a first format in accordance with the request data;
requesting, from an associated seller, at least one second document in a second format wherein the at least one second document in the second format is associated with the at least one first document in the first format
acquiring, from an associated seller, the requested at least one second document in the second format; and
communicating a response to an associated buyer wherein the response is inclusive of the at least one second document in the second format acquired from an associated seller.

14. The computer-implemented method for facilitating web-based transactions between an associated buyer and an associated seller of claim 13 wherein the at least one second document in the second format is one of the group consisting of a document in the second format specifically identified in the at least one first document in the first format, and a default document in the second format.

15. The computer-implemented method for facilitating web-based transactions between an associated buyer and an associated seller of claim 14 wherein the at least one first document in the first format is inclusive of a pointer to a specific at least one second document in the second format.

16. The computer-implemented method for facilitating web-based transactions between an associated buyer and an associated seller of claim 15 further comprising the step of dynamically updating the pointer comprised in the at least one first document in the first format in response to the type of received request data.

17. The computer-implemented method for facilitating web-based transactions between an associated buyer and an associated seller of claim 13 wherein:
the first format is eXtensible Markup Language (XML) format; and
the second format is eXtensible Stylesheet Language (XSL) format.

18. The computer-implemented method for facilitating web-based transactions between an associated buyer and an associated seller of claim 13 wherein the request data is web page data of an associated seller.
